(19) United States
(12) Patent Application Publication
(10) Pub. No.: US 2023/0354800 A1
(43) Pub. Date: Nov. 9, 2023

(54) SOLAR POWERED AQUATIC SPECIES TREATMENT APPARATUS AND METHOD

(71) Applicants: JOHN J. PAOLUCCIO, MODESTO, CA (US); JOHN A. PAOLUCCIO, MODESTO, CA (US)

(72) Inventors: JOHN J. PAOLUCCIO, MODESTO, CA (US); JOHN A. PAOLUCCIO, MODESTO, CA (US)

(21) Appl. No.: 17/739,188

(22) Filed: May 9, 2022

(51) Int. Cl. A01M 29/10; A01M 21/00; B63B 59/04; B63B 35/44

(52) U.S. Cl. CPC A01M 29/10; A01M 21/00; B63B 59/04; B63B 35/44; B63B 2035/4453; H02S 10/40

(57) ABSTRACT

A method for remediation, control, and mitigation of aquatic species by killing, damaging, weakening, and or reducing the growth of living organisms or species on and under the surface of a body of water. A solar collector array powers a UVC light array comprising a plurality of UVC lights that have sufficient UVC power to control and mitigate aquatic species by killing, damaging, weakening and or reducing the growth of living organisms or species under or on the surface of a body water. The method includes remotely maneuvering the UVC light array on or under the surface of a body of water.

### CROSS-REFERENCE TO RELATED APPLICATIONS

This application contains subject matter which is related to the subject matter of the following applications, each of which is having the same inventive entity and ownership as this application. Each of the below listed applications is hereby incorporated herein by reference in its entirety:

U.S. Pat. No. 11,191,260 Aquatic Organism Treatment Method and Apparatus.

U.S. Pat. No. 10,123,525 Aquatic Plant Treatment Method and Apparatus with Flotation Containment Chamber.

U.S. Pat. No. 9,622,465 Short-Wavelength Ultraviolet Light Array for Aquatic Invasive Weed Species Control Apparatus and Method.

The present invention provides still further benefits not previously disclosed.

### BACKGROUND OF THE INVENTION

The present invention relates to the remediation of invasive and native species including aquatic invasive weed species as well as mussels, clams, plants and still other aquatic species disposed in bodies of water including but not limited to lakes, ponds, ocean bays, sumps, tanks, vaults, containers trash cans, sumps, tanks, vaults, containers and trash cans and other bodies of water that are exposed to wet, damp or humid environments that become an ideal habitat where gnats, fly's and other insects and their eggs thrive. Although the description herein prominently refers to lakes and weeds, it will be understood that exemplary description is an example of a much greater number of invasive and native species and bodies of water and wet areas to which the present invention has application. Similarly, although the present application refers, for example to weeds and organisms under water, it will be understood that, for example, a weed may have a part underwater as well as on the surface of a body of water or even extend above a body of water.

The term “body of water” as used herein includes, but is not limited to, any liquid that includes water that is part of any ocean, sea, canal, waterway, pool, pond, lake or disposed within a vault, stormwater basin, sump or other container holding a liquid that includes that includes water or have a wet, damp or humid environment.

The method and apparatus in accordance with present invention utilizes a remotely controlled UVC array treatment to kill, damage, weaken and/or reduce growth of plants and other living organisms or species. Although the description herein may focus on one or more organisms or one or more species, it will be understood that all embodiments may be utilized with respect to species and/or organisms.

Other embodiments of the invention use antimicrobial LEDs instead of UVC light arrays or in in combination with UVC lights. Antimicrobial LEDs action of killing microorganisms is different than that of UVC light. UVC penetrates and damages DNA leaving cells unable to perform vital functions, leading to cell death. UVC light can affect DNA in humans. Antimicrobial LED does not have any impact on DNA. Antimicrobial LEDs do their work by killing microbial cells through photoactivating particular types of porphyrin molecules that are present exclusively in these microbial cells. When activated, they produce excessive Reactive Oxygen Species (ROS). Once an excess of ROS builds up inside the cells, they become toxic, causing the destruction of cellular structures and ultimately lead to cell death. Antimicrobial LED meets the international standard (set by the International Electrotechnical Commission or IEC) for continuous and unrestricted use around people.

Antimicrobial LEDs key benefit is that it can be used continuously around people and on any surface to kill bacteria, mold, mildew, fungi and yeast. There is no limit on the amount of exposure. This means the technology can be used around the clock for continuous protection. Its antimicrobial action not only kills these microorganisms over time, but it prevents their growth and regrowth.

Another benefit of this antimicrobial technology is that it also produces visible wavelengths of light that can act as a high-quality white light source. This provides the dual benefit of microbial protection and lighting. This makes the technology ideal for use in traditional overhead lighting to illuminate large places as well as in very small spaces, such as inside an elevator button, while delivering continuous antimicrobial protection in our homes, our workplaces and in virtually every industry.

Although a description herein may refer to UVC or UV-C, it will be understood that embodiment of the present invention may alternatively use antimicrobial LEDs or a combination of antimicrobial LEDs and UVC lights.

UVC light waves are used in the treatment method as described in U.S. Pat. No. 11,191,260 that is incorporated by reference herein. The present application describes apparatus and a method to expand the number and types of apparatus and treatment methods to battle the growing global environmental problems caused by invasive aquatic and native species. The infestation of aquatic plants in lakes, ponds and waterways is growing rapidly and prior art methods have not been effective or practical and new and better treatment methods are desirable. The UVC ultraviolet light wave treatment method incorporated by reference in this application, describes in greater detail the technology that may be combined with the apparatus described herein. There is a need for the use of UVC as a treatment method that kills or damages certain species to reduce the harm, diseases, nuisance, contamination, or other problems caused by both invasive and or native species that seek wet, damp, or humid habitats. This includes a broad range of living species from plants, fish, mussels, mosquitos, gnats, flies, and other insects and microorganisms. Depending on the distance, power, and obstructions, UVC rays can pass through air and water to provide a lethal dose of light rays that are effective to treat most species. This invention expands the possibilities for utilization of UVC in hard to access areas with use of remote or stationary control to improve our environment.

Prior art aquatic weed remediation apparatus and methods include mechanical harvesters, mowers, hand pulling, smothering or barrier mats and herbicides are the primary aquatic plant treatment and control methods currently used. One of the above current methods used to treat and kill milfoil (aquatic plants) is barrier mats that cover and smother the plants. Divers swim out to an infected area and submerge a large plastic, or rubber, or fabric mat on top of the milfoil. Some mats are in large rolls that are unrolled underwater. They add weights to hold the mats in place at the floor of the body of water. (The term “floor” used herein refers to the land mass that supports a body of water.) The mat may have slits or vents to allow air and accumulated gases produced by decaying material to escape. The covered plants are killed by the smothering action of the mats. The mats may remain over the plants for three (3) months before divers retrieve the mats. The used mats require cleaning and decontamination after use. The mats are typically rolled up for storage until ready for use. Herbicides may be used for treatment using surface sprays or by hose directly under water.

The prior art methods and apparatus involve complications. For example, mechanical harvesting methods leave behind enormous quantities of plant fragments that end up growing and causing additional infestations. Barrier mats require multiple divers to swim to an infested milfoil plant area and lower the mats over the milfoil. The divers then must add weights to prevent the mats from drifting away due to water currents. After 3 months, the divers need to return and remove the weights and the mats. Installation and removal are very time consuming and extremely costly operations. This task is dangerous work for the divers. While such mat sits on the floor of the body of water for months, some plants will grow through the vent slits and sediment settles on top of the mats making removal and cleaning of the mats exceedingly difficult. Because plants become resistant to herbicides, increasing doses, and increasing application frequency are required.

Prior art aquatic weed remediation apparatus and methods include mechanical harvesters, mowers, hand pulling, smothering, or barrier mats and herbicides are the primary aquatic plant treatment and control methods currently used. One of the above current methods used to treat and kill milfoil aquatic plants utilizes barrier mats that cover and smother the plants. Divers swim out to an infected area and submerge a large plastic, or rubber, or fabric mat on top of the milfoil. Some mats are stored in large rolls that are unrolled underwater. Weights are added to hold the mats in place on the floor of the body of water. The term “floor” as used herein refers to the landmass that supports a body of water. The mat may have slits or vents to allow air and built-up gases produced by decaying material to escape. The covered plants are killed by the smothering action of the mats. The mats may remain over the plants for three (3) months before divers retrieve the mats. The retrieved mats need cleaning and decontamination after use. Remediation may also be achieved with herbicide treatments applied by surface sprays or by hose directly underwater.

The prior art methods and apparatus involve complications and side effects. For example, mechanical harvesting methods leave behind massive quantities of plant fragments that end up growing and causing additional infestations. Barrier mats require multiple divers to swim to an infested milfoil plant area and lower the mats over the milfoil. The divers must add weights to prevent the mats from drifting away due to water currents. After three months, the divers need to return and remove the weights and the mats. Installation and removal require a very time-consuming and extremely costly operation considered dangerous work for the divers. While such mat sits on the floor of the body of water for months, plants will grow through the vent slits and sediment will settle on top of the mats making removal and cleaning of the mats exceedingly difficult.

From the above, it is apparent that there exists a need in the art to overcome the deficiencies and limitations described herein.

### SUMMARY OF THE INVENTION

The shortcomings of the prior art are overcome and additional advantages are provided through apparatus for remediation, control and mitigation of aquatic species by killing, damaging, weakening and or reducing growth of living organisms or species that are on, above or under the surface of a body of water including but not limited to lakes, ponds, ocean bays, sumps, tanks, vaults, trash cans, sumps, tanks, vaults, containers and other bodies of water that are exposed to wet, damp or humid environments which includes a solar collector array, a UVC light array, comprising a plurality of UVC lights, powered by the solar collector having sufficient UVC power to control and mitigation of living organisms or species.

The apparatus includes apparatus for remotely maneuvering the UVC light array on or under the surface of a body of water, whereby the apparatus for maneuvering movement of the UVC light array to kill, damage, weaken and or reduce growth of living organisms or species.

In some embodiments, the apparatus includes a buoyant structure floating on the surface of a body water. The apparatus may include apparatus for storing electric power produced by the solar array. The solar collector array provides power to move the buoyant structure and power the UVC light array. In some embodiments, the apparatus may be stationary as in a sump or container.

The apparatus for maneuvering may include at least one winch to raise and lower the UVC light array. Embodiments have a apparatus for maneuvering that includes a crane mounted on the buoyant structure.

The apparatus for maneuvering may include a submersible UVC light array including an electric motor-operated liquid pump by electric energy derived from the solar collector, pump directing the output thereof out one or more nozzles to position the submersible UVC light array.

The buoyant structure, as well as the UVC light array, may be propelled by a structure selected from the group consisting of a propeller disposed in the water, a propeller for moving air above the water, or a pumped water jet. The light array may have multiple portions. Portions of the light array are sequentially energized for a predetermined time intervals in some embodiments. Embodiments are programmable control movement of the buoyant structure, illumination of respective UVC lights, and the position of the UVC light array.

The present invention also includes a method for remediation, control and mitigation of aquatic species and/or organisms by killing, damaging, weakening and or reducing growth of living organisms or species on or under the surface of a body water which includes providing a solar collector array, providing a UVC light array powered by the solar collector having sufficient UVC power to, control and mitigate aquatic species by killing, damaging, weakening and or reducing growth of living organisms or species under the surface of a body water.

Embodiments of the method include a step of providing an apparatus that includes providing a buoyant structure floating on the surface of a body of water. The step of providing an apparatus may include providing apparatus for storing electric power produced by the solar array. The method may further includes providing electric power from the solar collector array to move the buoyant structure.

The method may include a step of providing apparatus for maneuvering that includes providing at least one winch and/or one crane to raise and lower the UVC light array.

The method may include a step of providing apparatus for maneuvering that includes providing a submersible UVC light array including an electric motor-powered liquid pump powered by electric energy derived from the solar collector and directing the output thereof out one or more nozzles to position the submersible UVC light array.

Embodiments may include a first electric docking connection on the buoyant structure that is dimensioned and configured for engagement and electric power transmission to a second electrical power connection coupled to an electric power source whereby remote-control maneuvering of the buoyant structure can connect and disconnect external electric power to the buoyant structure. Accordingly, electric power from an electric docking station maintains sufficient power in the batteries. When the batteries are low in energy, the remote or programmable apparatus will position the apparatus back to the docking station to recharge the batteries, as necessary. At nighttime and during periods of foul weather the apparatus is remotely or programmed to return automatically to the home docking station for protection.

The home docking station will be positioned, for example, on land, a dock, a barge, or a boat.

The remote operated apparatus in accordance with embodiments of the present invention will maintain digital, video or camera contact with the UVC apparatus whereby a human operator may establish to direct the UVC apparatus to direct the apparatus to conduct surveillance, treatment, inspection, measurements, optical recognition of species, mapping, or other tasks directed by operator.

One embodiment of the present invention includes a stationary solar powered apparatus fixed to a container or trash can wherein the UVC light portion of the apparatus extends into the interior of the container thereby exposing the UVC light rays within the wet, damp, or humid contents where it can treat, kill or damage insects and their progeny within said container before they escape from the container and enter the ambient environment.

The method also includes UVC treatment of a trash container having a body and a cooperating lid that includes a solar cell on the exterior of the trash can and a UVC light portion that extends into the interior of the container thereby exposing the UVC light rays within the wet, damp, or humid contents of the trash container to treat, kill or damage insects and their off spring within said container before they escape from the container and enter the ambient. A switch coupled to the lid and the body prevents electric power from the solar cell passing to the UVC light unless the lid is coupled to the body.

Another embodiment includes control apparatus to direct the UVC light array to help prevent a buildup of plants, algae, mussel, and other species on the underside of ships that would cause additional drag that results in more fuel power needed to overcome the drag friction.

Accordingly, it is an object of the present invention to minimize (1) labor costs and (2) energy costs, and (3) costs of material to achieve a thorough response to an invasive species or organism.

It is another object of the present invention to minimize any environmental impact.

It is yet another object of the present invention to utilize a method and apparatus that does not require any chemicals or herbicides or costly power.

It is a still further object of the present invention to utilize the solar energy that is typically readily accessible on bodies of water because there are usually no hills, trees, or buildings to obstruct sunlight.

Additional features and advantages are accomplished through the techniques of the present invention. Other embodiments and aspects of the invention as described in detail herein are considered a part of the claimed invention.

The recitation herein of desirable objects which are met by various embodiments of the present invention is not meant to imply or suggest that any or all such objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. Although specific features of various exemplary embodiments of the invention are shown in some drawings and not in others, this is for convenience only. In accordance with the principles of the invention, any feature of a drawing maybe referenced and/or claimed in combination with any feature of any other drawing.

The invention, however, both as to organization and method of practice, together with the further objects and advantages thereof, are understood by reference to the following description taken in connection with the accompanying drawings in which:

FIG. 1 is a schematic elevation view of the apparatus 10 that floats on the surface of a body of water for treating aquatic plants. Solar collectors collect solar energy. Batteries store the electric energy for timers and controls for remote control. The control may be implemented with or without programmable apparatus,

FIG. 2 is a schematic elevation view showing a floatation barge with a crane that suspends an ultraviolet light array (UVC array) into the water and allows lifting the array above the water for inspection, cleaning, and service,

FIG. 3 is schematic elevation view shows an embodiment that includes a module tethered to a floating mother station. The module includes apparatus for propulsion enabling to move on or below the surface of the water to treat respective locations that harbor invasive species. The module includes a UVC array and in some embodiments one or more cameras to facilitate treating specific objects or areas on or underwater,

FIG. 4 is a schematic illustrating a remote-controlled UVC array towed by a solar-powered barge. One or more legs extending from the UVC array to maintain a spaced relationship between the array and the floor of the body of water.

FIG. 5 is a schematic elevation view showing the UVC lights above the water surface to treat aquatic plant portions that grow above the surface of the water.

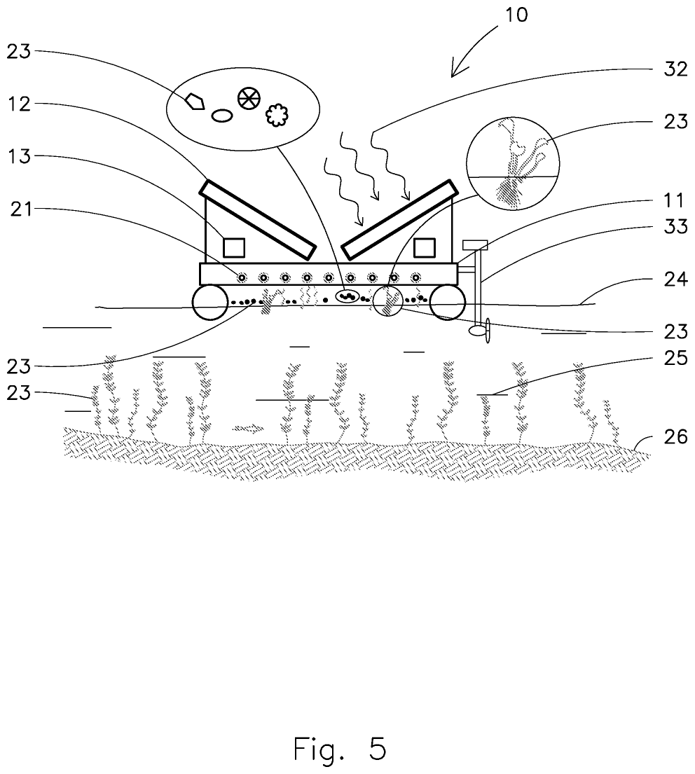

FIG. 6 is a schematic elevation view of the solar powered apparatus in a stationary embodiment, attached to a container or trash can where the UVC light rays extend into the container or trash can to treat mosquitos, insects, and their eggs before they escape into the ambient environment.

### DETAILED DESCRIPTION

Embodiments of the present invention have substantial advantages over the prior art apparatus and method. The present invention allows for remote operation and requires no divers to deploy or remove the apparatus. The chamber method allows for rapid herbicide treatment of concentrated milfoil plants within the containment volume that takes only minutes versus months with barrier mats. The isolated treatment volume of the containment volume of the chamber is a small fraction of the full height water column volume above the chamber from prior art herbicide treatment, thus allowing for a minimum of herbicide use only in the containment volume that may only be 1% or prior art herbicide use. This allows for precise herbicide concentration control for treatment and apparatus are provided for herbicide reuse and or filtration. This method is faster, safer, easy to control, less costly, more effective, and less polluting than prior art herbicide methods.

An advantage of the present invention over the prior art is that it utilizes electric power that can be harvested from the sun's rays and then stored to eliminate the need for continually using fossil fuel to generate electricity for the apparatus. Accordingly, the apparatus can be unmanned and operate for weeks, or months once programmed. Embodiments of the apparatus are of any size from a few square feet to thousands of square feet. Various embodiments have a shape that includes, but not limited to, a square, rectangular, round, or any other shape desired. The UVC light array may be the same size as the floatation barge supporting the solar collectors in some embodiments.

Remote programming and tracking controls allow for the speed and movement of the apparatus to follow any desired grid or other pattern to treat large areas of a body of water. This ensures that maximum treatment occurs.

The unmanned operation allows for the UVC apparatus to treat plants without the need for a full-time operator. Once programmed, the remote control may operate, for example, for a month or more without an operator. This constitutes a considerable labor cost saving.

The present apparatus is much safer than the prior apparatus because there is no need to place an operator on board the apparatus during remote operation or programmed operation.

Advantageously, the remote control which may also include programmable apparatus programmed to, for example, move apparatus in a grid pattern is particularly advantageous. For example, this construction eliminates the need to provide onboard space for an operator as well as the need to provide sleeping or bathroom facilities for an operator in addition to the need to provide buoyancy for the operator and associated facilities.

Still another advantage is that the reliance on solar energy to position the apparatus as well as to power the UVC lamps eliminate the cost of fuel in addition to the logistics of delivering fuel as well as space and buoyancy required to utilize, for example, fossil fuel. The energy collected from the solar light rays can provide enough energy for powering the UVC lamps and other apparatus on the array.

The cost reduction will, for example, be apparent with respect to a small fire pond that provides a water reservoir for extinguishing a fire in the vicinity of the pond. Embodiments of the present invention may utilize the remote control either with or without programmable features for treating aquatic species without the need for any chemicals, pesticides or herbicides or costly power.

For some applications LED-UVC lamps, bulbs or strips are selected that produce specific frequencies within the UVC sterilization range that are particularly effective for a particular target organism or invasive species. These may be encased in quartz sleeves to make waterproof. They may also be protected with waterproof coating or fluoropolymer-based films (FEP).

The present apparatus avoids both air and water pollution side effects because substantially all electric power used is derived from the sun and essentially no sounds are produced.

The elimination of an internal combustion engine, fossil fuel for an internal combustion engine, a crew as well as food, shelter, housing, and amenities for a crew, etc. result in an entire UVC apparatus that weighs a fraction of a conventional fossil fuel operated vessel.

The invasive species industry typically considers a plant population to be under “control” if plant growth is reduced by 75% or if there is only minimal interference with recreational boating or swimming activities. The apparatus in accordance with the present invention offers a apparatus to efficiently control plant growth and prevent out-of-control infestations. Seeds and turions may survive buried for over 10 years thus providing new growth. Continued prompt treatment can gradually reduce the development of new turions for more effective treatment.

The present invention allows unmanned operation in contaminated ponds. Thus, many ponds that contain chemicals or hazardous or odorous substances that are harmful to man would benefit from utilizing the present unmanned remote-controlled UVC array apparatus therein to help control aquatic species.

Particularly advantageous are embodiments that further include programmable features that are programmed to, for example, treat very large areas.

The entire UVC Apparatus boasts great simplicity of construction, simplicity to move to operational sites, simplicity of operation that minimizes learning curve issues for, for example, operators of marinas or other waterway entities. The apparatus can be launched and operated without the need for any ongoing workforce or fuel. For battery operated systems where, nearby electric power is always available, recharging the batteries can occur whenever the batteries are low. The controls will navigate the apparatus back to an electric docking station where the batteries to be recharged.

A promising application for the present apparatus is stagnating ponds. The remote-controlled UVC array is effective in controlling aquatic species such as mosquito larvae, shrimp, clams, algae bloom, and other undesired organisms in stagnate, warm or other water bodies and evaporation ponds or sumps with little or no circulation.

Another valuable solar UVC application includes sumps, vaults, containers, and trash cans that may be occasionally subject to wet, moist or humid conditions where mosquito or other insects thrive.

Still, another promising application for a remote controlled and tethered UVC aquatic treatment apparatus is for killing or damaging aquatic species from the underside of ships. Algae, mussels, and other species can attach and grow on the surface of ships and boats. This results in drag and increased fuel use to overcome the added resistance of the vessel moving through water.

The present invention does not require divers. Accordingly, the present invention eliminates the expense for divers and particularly divers working in hazardous conditions.

Because the present invention does not require any internal combustion engine there will be no danger of polluting the waterway and ambient air with fossil fuel spills in addition to pollution by combustion fumes and gases.

Because the present invention minimizes operating costs as well as being capable of relatively simple assembly, the apparatus has a fast payback.

Illustrative embodiment: One embodiment of the apparatus has a series of six (6) 4′×8′ array modules connected to form a 4′ wide by 48′ long array. The treated area under the array is 192 square feet. For the purposes of description, that area will be referred to herein as a “set”. For example, when the light array is positioned in an area of 384 sq. ft. for treatment and the UVC lamps are “ON” for an exposure time of 10 minutes per set, it will take 20 minutes to treat that area.

The treatment time, where the UVC lamps are “ON” varies depends on many factors. These include plant type, age, density, and degree of control; water quality and temperature; distance between plant or species and the UVC lamp; the size, type, and intensity of the UVC lamps, and emissions in the UVC range; and other factors. The exposure time may vary from just a few minutes to 15 minutes or more. An efficient method for determining exposure time is to treat a representative plant in an aquarium or testing lab with different exposure times.

The treated plants normally collapse in a few days and start to decompose in a week or two. Aquatic species such as mosquito eggs may, for example, be destroyed with a one minute exposure of lethal UVC rays.

Embodiments of the invention are programmable. Embodiments are programmed to move slowly in a grid pattern, in a circle or concentric circles, or any desired path or pattern. Embodiments of the apparatus are programmed to move slowly, or for example, move one set every five (5) minutes. At this rate, the treated area covered per hour would be: (192 square feet/Set)×(60 minutes/hour)/(5 minutes/Set)=2,304 Square feet/hour. Thus, a one-acre (43,560 Square Ft.) fire pond with the 192 Sq. Ft. array would require 43,560 square feet/192 square feet/Set or 227 Sets. At 5 minutes/Set it would take 5 min/Set×227 Sets÷60 minutes/hour=19 hours. Estimating, for example, 5 hours of sunshine per day, it would take 4 days for the apparatus to treat the fire pond. An operator could place the apparatus in the fire pond and program it to cover the pond area in a grid pattern for any length of time desired. Such treatment can be accomplished while unmanned.

In another embodiment of the present invention, for example, an anchor is dropped at one end of the array, and the entire 48′ long array is programmed to slowly rotate about the anchor. The treated area is then the area of a circle with a 48′ radius or 3.14×48×48=7,234 square feet. The treated area is then 28 times the area of the array. If the anchor was dropped in the center of the 48′ long array, the circle area covered would be 3.14×24×24=1,808 square feet or over 9 times the area of the array. The workforce saved is tremendous. The number of UVC lamps may vary in each array to provide the desired dose of UVC rays over the treated surface. Periodically, in one embodiment, the programmed controls cause the anchor to be raised, the barge is repositioned to another grid location and the programed controls drop the anchor again to repeat the treatment cycle.

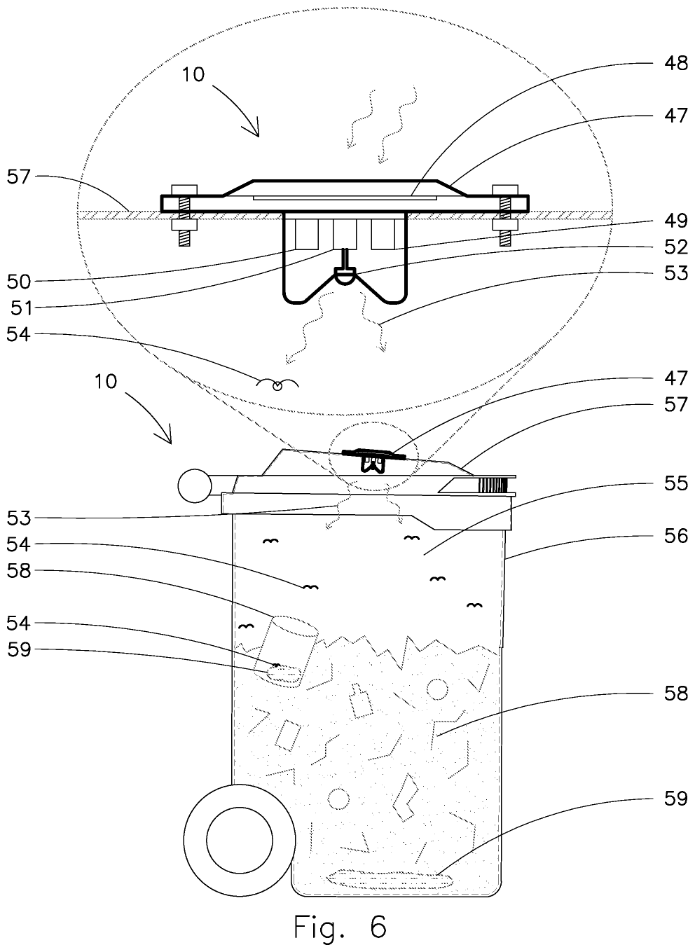

In another embodiment of the present invention, for example, as shown in FIG. 6 a fixed Solar UVC insect treatment apparatus is fitted to a trash can lid. When the lid is in a closed position, the UVC light is energized and be “ON” when sufficient solar power energizes the battery. When the lid is removed or disturbed, the electric power to the UV light is shut off. Power will remain off for a fixed period of time after the lid is closed. This prevents anyone from accidently looking at the UVC light rays that can damage eyes and skin.

The following is a listing of the reference numerals herein:
10 UVC Apparatus
11 Floatation support barge
12 Solar collector panels, controllers, and inverters
13 Battery
14 Timers
15 Controls & programming devices
16 Computers & tracking systems
17 Winches
18 Support cables
19 Electric wire and control wires
20 Remote controlled UVC array with one or more UVC lamps or bulbs
21 UVC light array with UV-C lamps, lights, bulbs, or LED's
22 UVC light rays in the sterilization range
23 Aquatic species, plants, algae, mussels, clams, larvae, or other microorganisms
24 Water surface
25 Water, pond, lake, or other water body, including stormwater basin or sump
26 Bottom of water or lake bottom
27 Docking receptor on the barge
28 Docking station, power charging on the dock
29 Operator
30 Remote controller—monitor, tracking system
31 Dock—land—land structure
32 Suns light rays
33 Outdoor motor—propeller or pump
34 Crane support
35 Crane extension arm
36 Fish deterrent—light, vibration, or sound
37 Tether with electric and control wire and support cable.
38 Propeller or pump jet for moving array
39 General area lights
40 Remote controlled UVC array
41 Camera and optical recognition system
42 Anchor and cable
43 Underwater structures with unwanted species to be treated
44 Pump propulsion unit
45 Support legs or flexible skirt can keep the array a fixed minimum distance from the bottom
46 Skid. This can keep the array above the bottom while moving
47 Solar apparatus housing
48 Solar collector in housing
49 Battery and or capacitor
50 Controls, wiring and sensors
51 connection port and switches for UVC lamp or UVC-LED bulb.
52 UVC lamp or UVC-LED bulb
53 UVC rays
54 Insects, fly's, gnats, maggots, and microorganisms
55 Wet, or humid air or environment within container
56 Container, bin or trash can
57 Cover or lid of container or trash can
58 Wet, moist or humid contents, food, trash or garbage in container.
59 Water in trash and at bottom of trash container

Additional description of some of the above items follow

The floatation support barge, boat, or vessel capable of supporting all attached components. The edges may be shaped to help deflect tall plants as it moves.

Solar collectors on a support frame that capture the sun's energy including energy storing batteries, converters, controls and associated trim.

Ultraviolet lamps in the “C” range: (UVC). The sterilization range may be near 254 nm and 280 nm. These may be mercury vapor, amalgams type lamps, LED-UVC lights, bulbs or strips, or other type lamps that can produce or generate light frequencies in the sterilization range or UVC.

UVC light array (array). This may be one or a combination of UVC lamps that are assembled into a modular array, for example, in one embodiment is 2′ wide by 4′ long. Other sizes may be desirable for other applications. Multiple arrays may be connected together to form a larger UVC array of any desired size or shape. Each array will be powered by solar collectors. Embodiments of the present invention lower the UVC array over the undesired aquatic species.

In one embodiment of the present invention, the array is programmed to travel to a docking station when low in electric power or at night where it automatically connects to an electric charging outlet to maximize the stored electric power in the batteries. This variation may be practical for example in a fire pond near a factory where ample electric power is available.

The UVC lamps in the array are arrayed in a linear array in embodiments of the present invention. In other embodiments, individual UVC lamps may be arranged to freely or loosely hang vertically in relation to the surface of the water so they can move and better infiltrate the target specie or organism. In embodiments, including embodiments that utilize LED-UVC type lights, the lights are arranged on a semi-flexible mat surface. The UVC array may have a plurality of UVC lamps having a geometric axis that is disposed vertically with respect to the bottom of the UVC array. This orientation is particularly useful for treating certain plants, for example, tall plants.

Embodiments of the UVC array may have the lights arranged in unique positions to treat distinct species. The unique positions may, for example, may be below or above the water. Thus, for example, for plants that float on the water, the lights are 1.) orientated upward to treat the roots and underside of the plants or 2.) supported above the surface of the water and focused downward on the top of the plant located on the water surface.

Battery, timers and other solar-powered components and controls, and electronic components for sending and receiving remote control signals are disposed, in various embodiments on a barge or land.

Remote control devices to control the apparatus include:

Winches for lowering and lifting the UVC light array.

An electric motor which may be either outboard or inboard moves the barge or other floatation device in any desired direction on the surface of the body of water. Embodiments may use a propeller disposed in the water, a propeller for moving air above the water, or a pumped water jet to propel the apparatus or light array; and

Remote controls, programmable apparatus, and programming to turn “On” and “Off” UVC array lights and other devices as well as to control speed, direction, anchoring, docking, and other operations.

Operation/Application:

The UVC treatment apparatus may, for example, be launched on a lake with the UVC array in the raised position under the barge. By using the remote controller, the barge can be moved by the outboard motor to a desired location from an operator onshore. The remote controller operates winches to lower the UVC light array to near the bottom of the lake proximate to the target species. In some cases, the apparatus may move slowly causing a deflector to push aside and or consolidate tall plants so the array can more effectively treat the plants. In other cases, the array may be raised and lowered to consolidate the plants for treatment.

While the array is being lowered, the physical mass thereof will deflect and consolidate the tall plants into a more confined area under the array that may be several inches or more above the bottom of the lake. In some embodiments, the array may be nearer to the surface to treat tall plants or species more effectively.

Although the present description may include descriptions for treating aquatic plants, those skilled in the art will recognize the applicability to aquatic species, including treating fish, clams, larvae, microbes, and other living organisms with UVC arrays. Each type of species may utilize unique UVC arrays and unique positions. For example, a species at the water surface or near the water surface species may require the array lamps slightly below, and/or, at or above the water surface to effectively administer the proper UVC dose and exposure of the light waves to damage or sterilize the target aquatic species being treated. Applications requiring application of UVC above the water surface are treated by arrays that are supported on a floating body having sufficient buoyancy to support a suitable UVC array and a suitable structure to support the UVC array in a manner to administer the proper UVC dose and exposure of the light waves to damage or sterilize the target aquatic species.

Whenever the sun is shining, part of the solar energy is collected by the solar collectors. This electric energy flows to a battery for storage and use. When the battery is charged to a predefined point the electric energy, by use of a timer and controller, will be used to energize all or part of the UVC lamps in the light array.

Embodiments have a light array arranged so that all or a portion of the array, for example, 25% of the UVC lamps are energized, for example, 20 minutes. Then the control timer may sequentially respective separate groups of UVC lamps, for example, 25% of the complete UVC lamp assembly. This sequence repeats as required.

This treatment is programmed and/or remote-controlled by an operator onshore in various embodiments of the present invention.

When a species treatment under the entire array is complete, the remote controller or programmed apparatus causes the winches to raise the UVC light array from above the bottom of the lake to any desired height up to the underside of the floatation barge. Then, the apparatus can be moved by the outdoor motor to another portion of the lake (or another body of water) to repeat the treatment process.

The UVC lamps in the array may be low-pressure mercury type, LED-UVC type, or another type that produces light wave energy in the “C” range of approximately 254 nm. The LED-UVC type may produce light having a wavelength near 265 nm and is preferred in certain smaller applications.

Other wavelengths outputs may also be used to treat the aquatic plants and other species. As described in the applicants' previous applications and patents, the UVC light rays damage or disrupt the cell structure and DNA of the plants and other aquatic species and cause them to be injured, die or be unable to reproduce. Thus, the UVC application will help in reducing the population of plants to an acceptable level to minimize plant growth problems interfering with recreation activities.

This invention is shown above for the treatment of aquatic plants, but other aquatic species may also be treated such as mussels, clams, algae, mosquito larvae, microorganisms, and other aquatic species.

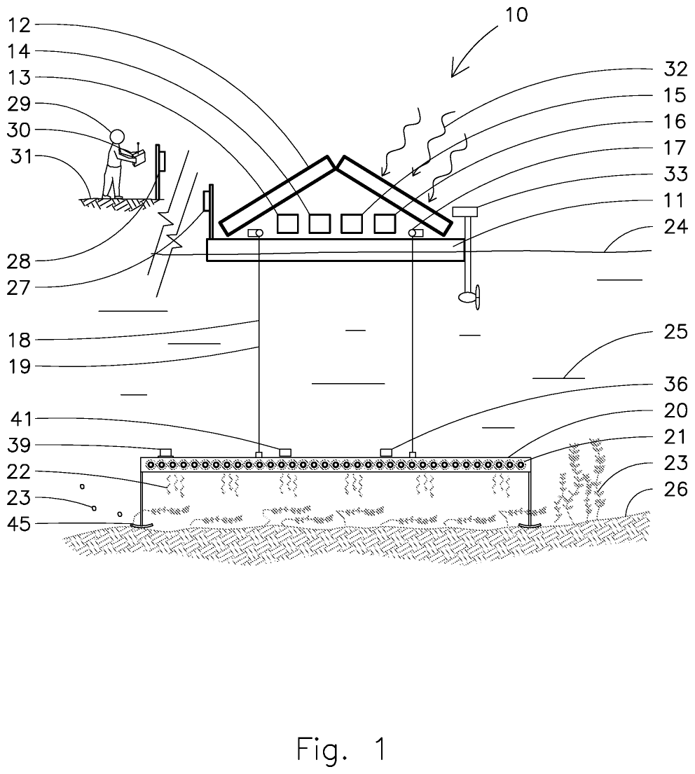

The UVC Apparatus 10 as shown in FIG. 1 shows a floatation barge 11 with framed solar collectors 12 that provide solar energy to storage batteries and for powering a UVC array 20. The floatation barge 11 supports batteries 13, timers 14, controls & programming 15, computers & tracking 16, winches 17 to raise and lower the UVC array 20 with cables 18 and wires 19 for power and controls.

The UVC array 20 includes one or more ultraviolet lights 21 that emit light rays 22 in the germicidal range that includes 254 nm. The light rays 22 can damage the cells of plants 22 and cause them to be weakened or die. The UVC array 20 can be positioned at any desired height between the bottom 26 of the water 25 and the underside of the floatation barge 11. The floatation barge 11 can be programmed 15 to travel in a specific grid or path, powered by an outboard motor 33.

In a variation of the solar-powered remote-operated invention, the UVC Apparatus may be pre-programmed to return to a docking station when low on stored electric power, or at night or when foul weather occurs. The docking station may have an automatic electric power transfer system that recharges the batteries on the Apparatus.

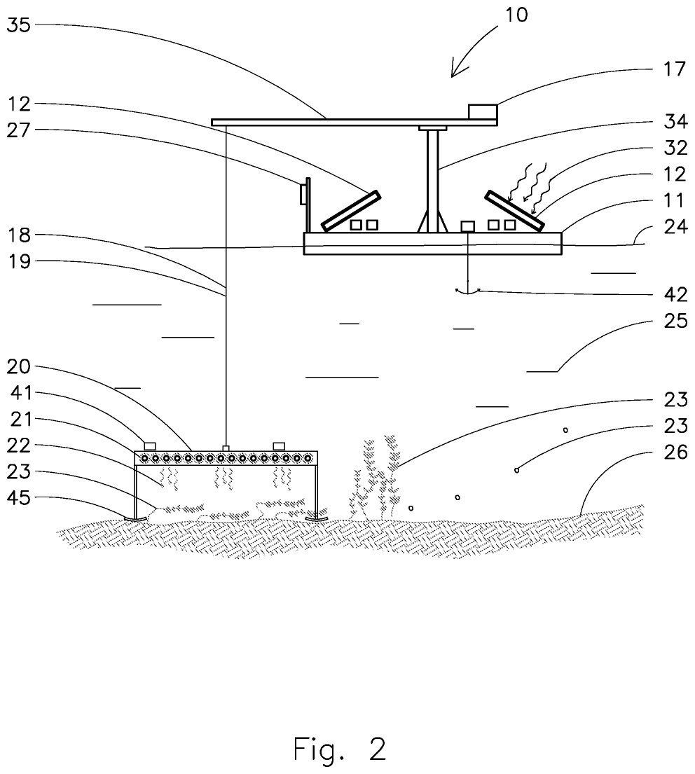

FIG. 2 shows a schematic view of the apparatus with a solar-powered barge 11 with a crane 34 and extension arm 35 supporting the UVC light array 20. The crane 34 and an extension arm 35 assembly allow the array 20 to be moved in any position around the barge 11. The extension arm 35 may also extend to both sides of the barge 11 for balance purposes and to double the speed of treatment. Multiple arrays 20 may also be used.

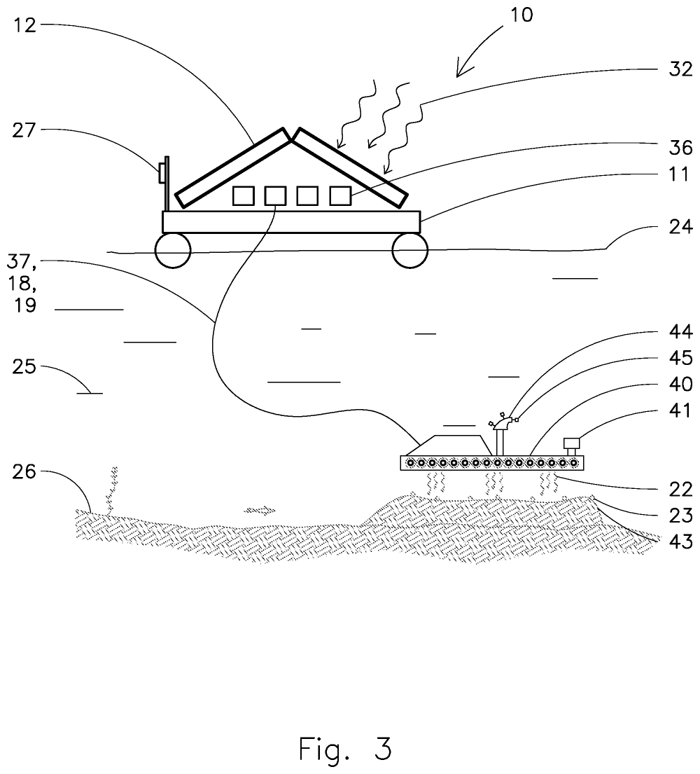

FIG. 3 shows a schematic drawing of an underwater remote operated array 20 that has a density close to the specific weight of water 25 and is solar 12 powered and tethered 37 so it can reach certain objects such as an underwater pier, column, or other structure 43 that may have, for example, an infestation of mussels 23 or other species that is to be treated. It may also be a pipe inlet or screen when used to control a species such as plants, mussels, or snails before they become an infestation and cause damage. The camera optical recognition system 41 and guided array 20 is propelled by a jet stream from a pump 44.

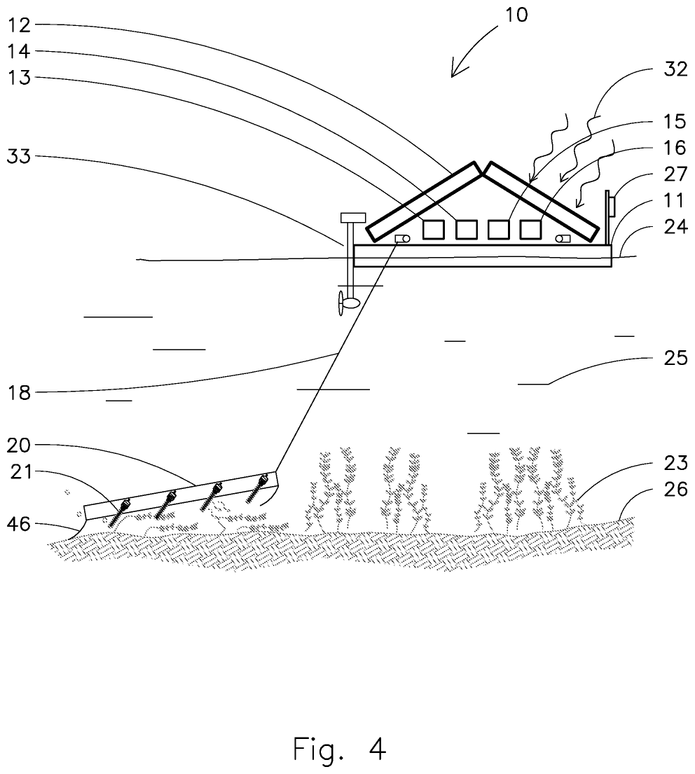

FIG. 4 schematically illustrates a UVC array being towed by a solar-powered barge. The UVC array includes a deflector 46 to support the UVC array in spaced relation from the floor of the lake or other body of water. The schematic illustration illustrates the radiation of UVC emanating from the bottom face of the UVC array.

Embodiments of the present invention utilize an underwater aquatic device carrying a UVC light array. In such embodiment the underwater aquatic device carrying a UVC light is remotely controlled to maneuver the device to kill, damage, weaken and/or reduce growth of plants and other living organisms or species.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

It will be understood that, in general, terms used herein, and especially in the appended claims, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood that if a specific number of an introduced claim recitation is intended such an intent will be explicitly recited in the claim, and in the absence of such recitation no such intent is present. For example, as an aid to understanding, the following appended claims may contain the usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “an imager” should typically be interpreted to mean “at least one imager”); the same holds true for the use of definite articles used to introduce claim recitations. In addition, even if a specific number of an introduced claim recitation is explicitly recited, it will be recognized that such recitation should typically be interpreted to mean at least the recited number (e.g., the bare recitation of “two images,” or “a plurality of images,” without other modifiers, typically apparatus at least two images). Furthermore, in those instances where a phrase such as “at least one of A, B, and C,” “at least one of A, B, or C,” or “an [item] selected from the group consisting of A, B, and C,” is used, in general, such a construction is intended to be disjunctive (e.g., any of these phrases would include but not be limited to systems that have A alone, B alone, C alone, A and B together, A and C together, B and C together, or A, B, and C together, and may further include more than one of A, B, or C, such as A₁, A₂, and C together, A, B₁, B₂, C₁, and C₂ together, or B₁ and B₂ together). It will be further understood that virtually any disjunctive word or phrase presenting two or more alternative terms, whether in the description, claims, or drawings, should be understood to contemplate the possibilities of including one of the terms, either of the terms or both terms. For example, the phrase “A or B” will be understood to include the possibilities of “A” or “B” or “A and B.”

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

While the invention is described in terms of various specific embodiments, those skilled in the art will recognize that the invention can be practiced with modification within the spirit and scope of the claims. While certain embodiments of the invention have been illustrated and described, various modifications are contemplated and can be made without departing from the spirit and scope of the invention. Accordingly, the invention is not to be limited, except as by the appended claim(s).

The teachings disclosed herein may be applied to other systems and such teachings are not limited to any identically described herein. The elements and steps of the various embodiments described herein can be combined to provide further embodiments. All the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Terminology used when describing certain features or aspects of the invention should not be taken to imply that the terminology is being refined herein to be restricted to any specific characteristics, features, or aspects of the present invention with which that terminology is associated. In general, the terms used in the following claims should not be constructed to limit the present invention to the specific embodiments disclosed in the specification unless the above description section explicitly defines such terms. Accordingly, the actual scope encompasses not only the disclosed embodiments but also all equivalent ways of practicing or implementing the disclosed present invention. The above description of embodiments of the present invention is not intended to be exhaustive or limited to the precise form disclosed above or to a particular field of usage.

While certain aspects of the present invention are presented below in particular claim forms, various aspects of the present invention are contemplated in any number of claim forms. Thus, the inventor reserves the right to add additional claims after filing the application to pursue such additional claim forms for other aspects of the present invention.

What is claimed is:

1. Apparatus for remediation, control, and mitigation of aquatic organisms and/or species by killing, damaging, weakening, and or reducing the growth of living organisms or species above, on and under the surface of a body of water which comprises:
a solar collector array;
a light array including lights selected from a group consisting of UVC lights and antimicrobial lights, comprising a plurality of the lights, powered by said solar collector having sufficient UVC power to control and mitigation of aquatic species by killing, damaging, weakening, and or reducing the growth of living organisms or species under the surface of a body water; and
apparatus for remotely maneuvering said light array on or under the surface of a body of water, said apparatus for maneuvering movement of the light array to kill, damage, weaken and or reduce the growth of living organisms or species under or on the surface of a body water.

2. The apparatus as described in claim 1 wherein said apparatus includes a buoyant structure floating on the surface of the body water.

3. The apparatus as described in claim 1 wherein said apparatus includes apparatus for storing electric power produced by said solar array.

4. The apparatus as described in claim 2 wherein said solar collector array provides power to move said buoyant structure.

5. The apparatus as described in claim 2 wherein said apparatus for maneuvering includes at least one winch to raise and lower the light array.

6. The apparatus as described in claim 2 wherein said apparatus for maneuvering includes a crane carried on said buoyant structure.

7. The apparatus as described in claim 2 wherein said apparatus for maneuvering includes a submersible light array including an electric motor operated liquid pump by electric energy derived from said solar collector, pump directing the output thereof out one or more nozzles to position the submersible light array.

8. The apparatus as described in claim 4 wherein said apparatus for maneuvering the buoyant structure and the light array includes structure selected from the group consisting of a propeller disposed in the water, a propeller for moving air above the water, or a pumped water jet.

9. The apparatus as described in claim 1 wherein said light array has multiple portions thereof and respective portions are sequentially energized for a predetermined time intervals.

10. The apparatus as described in claim 1 wherein said apparatus is programmable whereby movement of the buoyant structure, illumination of respective lights, and the position of the light array is programmable.

11. The method as described in claim 1 including further including communication apparatus allowing communication between said light array and a home docking station.

12. The method as described in claim 11 wherein the home docking station is disposed at a location selected from the group consisting of a land base, a dock, a barge, and a boat.

13. The apparatus as described in claim 2 wherein the speed of said buoyant structure is programmable.

14. The apparatus as described in claim 2 wherein a grid movement pattern of said buoyant structure is programmable.

15. The apparatus as described in claim 2 wherein a circular movement pattern of said buoyant structure is programmable.

16. The apparatus as described in claim 2 wherein a concentric circular movement pattern of said buoyant structure is programmable.

17. The method as described in claim 10 wherein said step of remote control treatment directs the light array to reduce any accumulation of plants, algae, mussel, and other species on the underside of a marine craft including boats, ships and submarines to minimize drag and improve fuel efficiency.

18. A container having
a body having an open top;
a lid dimensioned and configured for engagement with said open top, said lid having an outer surface and an inner surface;
a solar cell disposed on said outer surface of said lid;
a light array including lights selected from a group consisting of UVC lights and antimicrobial lights disposed on said inner surface of said lid, said light array extending into the interior of said container thereby projecting light rays into the container to expose any wet, damp, or humid location to treat, kill, or damage insects and their young within said container before they escape from the container and enter the ambient environment.

19. The container as described in claim 18 further including a switch responsive to engagement of said lid with said body whereby said light array only receives electric power when said lid is engaged with said body.
